(19) United States
(12) Patent Application Publication
(10) Pub. No.: US 2005/0198421 A1
(43) Pub. Date: Sep. 8, 2005

(54) Method to execute ACPI ASL code after trapping on an I/O or memory access

(76) Inventors: Rajeev K. Nalawadi, Folsom, CA (US); Victor M. Munoz, Orangevale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/796,350

(22) Filed: Mar. 8, 2004

(51) Int. Cl. G06F 13/00

(52) U.S. Cl. 710/260

(57) ABSTRACT

Embodiments may include an interrupt handling system to generate software level interrupts in place of hardware level interrupts. The interrupt handling system may invoke an advanced configuration and power management interface (ACPI) and ACPI source language infrastructure, which provides for an SCI independent mechanism for invoking ACPI ASL code. The ACPI ASL code may in turn be used to alter and configure the power management of a computer system. This interrupt handling system allows for greater flexibility and efficiency by utilizing software based interrupts in place of hardware interrupt to decrease pin counts for chips and allow isolation of system function based on address ranges tied to interrupt sources.

### BACKGROUND

1. Field

Embodiments of the invention relate to interrupt handling. Specifically, an exemplary embodiment relates to an interrupt handling system for correlating input/output and memory accesses with executing ACPI ASL code methods.

2. Background

In a typical computer system, many devices are running concurrently such as storage drives, printers and human input devices. An interrupt system is used to efficiently utilize processor time and resources. When a device has information to be processed by a processor or an event occurs in the computer system an interrupt signal is generated. When the interrupt signal is received by the processor, the processor stops the execution of the currently running program and an interrupt handler is executed to service the device or event that generated the interrupt signal. When the device or event has been serviced the processor returns to the execution of the program that was interrupted.

A chipset or input output (I/O) controller device may receive interrupt requests from each resource or device in the computer system. This requires that the chipset or controller have a mechanism to receive the interrupts from various devices in the system. One implementation requires a separate interrupt pin be connected from the device to chipset/controller to signal occurrences of the interrupt. A second implementation utilizes a virtual wire (message based) mechanism for delivering interrupts from device to the chipset/controller. Interrupt pins are relatively large structures to attach to a chipset or controller device. Accommodating a large number of devices or resources in a system requires a chipset to have a commensurate number of pins to receive interrupts from each device in consideration of optimal performance benefits versus sharing of interrupts between multiple devices. This results in a chipset or controller that has a large size to provide surface area for each of the pins to be attached to the chipset or controller. A large chipset or controller is more costly and less efficient than a smaller chipset or controller and occupies more space on a circuit board.

A typical computer system often manages the power state and the configuration of devices attached to the system. An operating system running on the computer system may use an interface such as an advanced configuration and power interface (ACPI) to manage the power state and configuration of devices in the computer system. The ACPI provides a set of data structures and methods for an operating system to utilize when interfacing with the basic input output system (BIOS) and mainboard hardware necessary for implementing the configuration or power management. ACPI source language (ASL) code is executed when an SCI interrupt is activated by the hardware. This interrupt is generated by power management events occurring in the computer system. All the power management events in the computer system are logically ‘OR’ed in the chipset/controller to generate an SCI.

A central processing unit in the computer system supports I/O protection. An I/O protection level (IOPL) field in an EFLAGS register is used to control access to I/O address space by restricting use of selected instructions. This protection mechanism permits an operating system (OS) to set a privilege level needed to perform I/O. The OS sets the permission level to allow a kernel and device drivers to perform I/O, while less privileged device drivers and application programs are denied access to the I/O address space. The following instructions can be executed only if the current privilege level of the program or task is less than or equal to the IOPL: IN, INS, OUT, OUTS. These instructions are called I/O sensitive instructions, because they are sensitive to the IOPL field. Any attempt by a less privileged program or task to use an I/O sensitive instruction results in a general-protection interrupt being signaled. Because each task has its own copy of the EFLAGS register, each task can have a different IOPL.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a computer system implementing an improved interrupt handling system.

FIG. 2 is a flowchart of one embodiment of a process for establishing an interrupt handling scheme.

FIG. 3 is a diagram of one embodiment of a process for handling an interrupt in an interrupt handling scheme.

FIG. 4 is a diagram of one embodiment of a system for handling interrupts.

### DETAILED DESCRIPTION

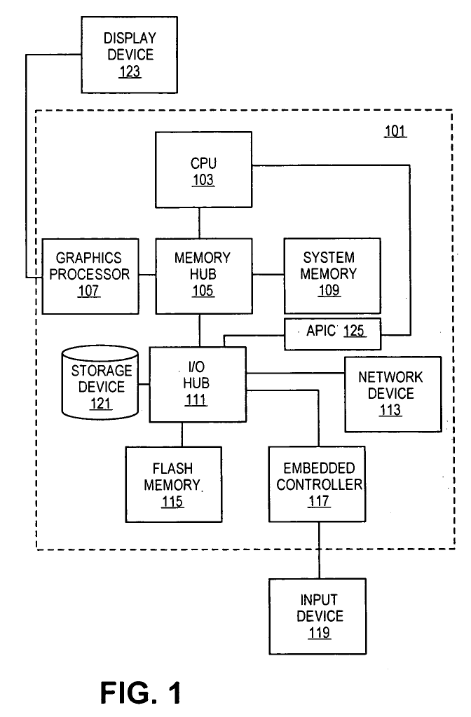

FIG. 1 is a diagram of one embodiment of a computer system. In one embodiment, computer system 101 may include a central processing unit (CPU) 103 to execute instructions. In another embodiment, computer system 101 may include multiple processors. CPU 103 may be located on or may be attached to a mainboard. In an embodiment with multiple processors, each processor may be located on or attached to the same mainboard or may be on separate mainboards. CPU 103 may be in communication with a memory hub 105 or similar device.

In one embodiment, memory hub 105 provides a communication link between CPU 103 and system memory 109, input-output (I/O) hub 111 and similar devices such as graphics processor 107. In one embodiment, memory hub 105 may be a ‘North Bridge’ chipset or similar device.

In one embodiment, system memory 109 may be a random access memory (RAM) module or set of modules. In one embodiment, system memory 109 may be synchronized dynamic random access memory (SDRAM), double data rate (DDR) RAM or similar memory storage devices. System memory 109 may be used by computer system 101 to store application data, configuration data and similar data. System memory 109 may be volatile memory that loses data when computer system 101 powers down.

In one embodiment, other devices may be connected to memory hub 105 such as a graphics processor 107. Graphics processor 107 may be located directly on the mainboard. In another embodiment, graphics processor 107 may be located on a separate board attached to the mainboard through an interconnect or port. For example, graphics processor 107 may be located on a peripheral card attached to the mainboard through an advanced graphics port (AGP) slot or similar connection. A graphics card or graphics processor 107 may be connected to a display device 123. In one embodiment, display device 123 may be a cathode ray tube (CRT) device, liquid crystal display (LCD), plasma device or similar display device.

In one embodiment, memory hub 105 may be in communication with an I/O hub 111. I/O hub 111 provides communication with a set of I/O devices and similar devices such as storage device 121, flash memory 115, embedded controller 117, network device 113 and similar devices. In one embodiment, I/O hub 111 may be a ‘South Bridge’ chipset or similar device. In another embodiment, memory hub 105 and I/O hub 111 may be a single device.

In one embodiment, an advanced programmable interrupt controller (APIC) 125 may be in communication with I/O hub 111 and CPU 103. APIC 125 is a device that may handle interrupts from and for multiple devices and CPUs. APIC 125 may be connected to additional devices that may be the ultimate source of an interrupt. I/O hub 111 and APIC 125 handle accepted interrupts from devices and may pass these interrupt requests to CPU 103. In one embodiment, I/O hub 111 may directly send an interrupt through the memory hub 105 and finally to CPU 103.

In one embodiment, storage device 121 is a non-volatile storage device such as a fixed disk, physical drive, optical drive, magnetic drive or similar device. Storage device 121 may be used to store application data, operating system data and similar system data. In one embodiment, flash memory 115 may store system configuration information, basic input output system (BIOS) data and similar information. Flash memory may be an electronically erasable programmable read only memory (EEPROM), battery backed up memory device such as complementary metal oxide semiconductor (CMOS) or similar non-volatile storage system.

In one embodiment, an embedded controller may be connected to I/O hub 111. An embedded controller 117 is a type of microcontroller that performs complex low level operations in computer system 101. In one embodiment, embedded controller 117 may function as an input device controller serving as an interface between computer system 101 and an input device 119.

In one embodiment, other devices such as a network device 113 may be in communication with I/O hub 111. Network device 113 may be a modem, network card, wireless device or similar device. In one embodiment, network device 113 is integrated into the mainboard. In another embodiment, network device 113 is a peripheral card connected to the mainboard through a Peripheral Component Interconnect (PCI) slot or PCI Express slot or similar interconnect.

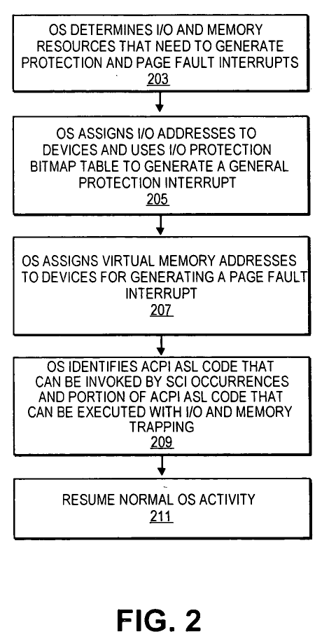

FIG. 2 is a flowchart of one embodiment of a process for the establishment of an interrupt handling scheme. In one embodiment, a computer system, during a boot phase or reboot phase, may determine which resources and devices in the system require interrupt handling (block 203). The devices and resources that are determined to require interrupt handling may be input/output devices, resources or devices that utilize memory in the computer system or similar resources and devices. In one embodiment, a device or resource in the computer system may be configured to generate an interrupt by generating a hardware interrupt such as a system control interrupt (SCI) or similar hardwired interrupt based on Power management event occurrences. Alternatively, a device or resource may indirectly generate an interrupt by requesting an access to an I/O port or address or an access to a memory address. In one embodiment, an operating system (OS) during system start-up or restart determines which I/O and memory resources need to generate general protection faults or page fault interrupts. Interrupts may include exceptions which are typically a set of interrupts corresponding to interrupt handler 0 to 15 in a system.

In one embodiment, an operating system assigns I/O address ranges to resources or devices that are configurable to access I/O addresses or ports (block 205). The operating system may be configured to trap accesses, such as read or write requests, to addresses in this assigned range of I/O addresses or ports. In one embodiment, I/O addresses and ports may be monitored by an operating system using an I/O protection bitmap or similar data structure. The I/O protection bitmap tracks a set of I/O addresses and ports to prevent inappropriate accesses to these addresses. An operating system may utilize this protection system to implement an interrupt handling scheme by assigning address ranges to I/O devices and resources and trapping their accesses to these addresses. The interrupts generated by the access to these I/O addresses are conventionally general protection faults. These interrupts are software generated and obviate the need for the device or resource that utilizes an I/O address or port in a designated address range to have a designated interrupt line. This address range may be assigned when a driver for a resource or device registers with the operating system. The driver or operating system may configure the device to make accesses to the I/O address range to generate a processor exception interrupt when needed to service the resource or device.

In one embodiment, the operating system may assign virtual address ranges for memory to resources or devices that may be configured to access memory (block 207). An operating system may protect memory address space from inappropriate or malicious accesses by use of a paging scheme. An operating system may divide virtual memory into a set of pages. In one embodiment, the pages may be four kilobytes in size. In another embodiment, the pages may be any size. The pages may be tracked in a page table. A program, resource or device that accesses a virtual address outside its allotted range or a virtual address not currently in memory may generate a processor exception interrupt in the form of a page fault. A page fault may be a software type interrupt. The use of the page fault obviates the need for a hardware type interrupt for a resource or device. In one embodiment, an address may be assigned to a resource or device when its driver registers with the operating system. The driver or operating system may configure the device or resource to access a memory range when it needs to be serviced.

In one embodiment, the number of interrupt lines used in a computer system may be decreased by use of overloaded page faults and general protection faults to service resources or devices in the computer system. The interrupt lines that are replaced may be related to power management interrupts including power management event (PME) interrupts, GPI interrupts, and similar interrupts. The increased use of software based interrupts may allow a computer system to invoke ACPI ASL code by using an SCI independent mechanism. In another embodiment, the computer system and operating system may continue to support hardware generated interrupts such as SCI type interrupts.

In one embodiment, an operating system may identify resources and devices that may utilize advanced control and power interface (ACPI) source language (ASL) control methods (block 209). The ASL control methods may be correlated with the resources and devices that may be serviced by these control methods. In one embodiment, the interrupt handler for SCI interrupts, general protection faults, and page faults may be configured to invoke related ASL control methods. ASL control methods may be utilized to reconfigure system resources and devices and to alter the power state of resources and devices in the computer system. In one embodiment, after the interrupt handlers have been configured the operating system may resume normal operation (block 211).

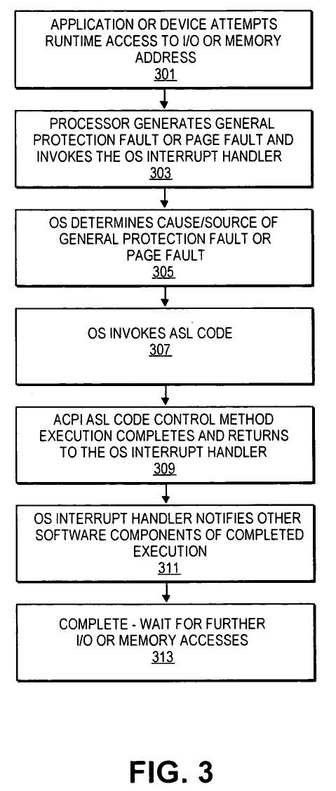

FIG. 3 is a flowchart of one embodiment of a process for handling software based interrupts in an interrupt handling scheme. In one embodiment, a resource or device attempts to access an I/O address or port or a virtual memory address (block 301). The I/O address or port may be designated as a protected address or port in the I/O protection bitmap. The virtual memory address may be designated as a protected address in the memory protection scheme implemented by the operating system.

In one embodiment, when an I/O access or memory access occurs an interrupt is generated (block 303). An I/O access by a resource or device to a designated I/O address or port may generate a general protection fault type interrupt or similar interrupt type. A memory access by a resource or device to a designated virtual memory address may generate a page fault or similar interrupt type. In one embodiment, the processor generates the appropriate fault type. In response to the fault, an operating system may invoke an interrupt handler to receive the fault, a software interrupt, based on the I/O access or memory access.

In one embodiment, an interrupt handler may determine the proper routine to handle the interrupt (block 305). The interrupt handler may be a set of service routines and a switch or similar structure that determines which routine to apply to handle the interrupt. The interrupt handler may determine the proper service routine by correlating the address that was accessed with a routine designated to handle an address range including the accessed address. The interrupt hander may also make a determination of the service routine based on the type of interrupt that was generated such as a general protection fault, page fault, SCI or similar interrupt type.

In one embodiment, an ASL code method may be invoked by an interrupt service routine (block 307). The interrupt service routine selected by the OS interrupt handler may include a call to one or more ASL code methods or utilize ACPI data structures. The ACPI may be used to modify the configuration of a device or resource or to alter the power state and configuration of the computer system, components of the computer system and similar structures. In one embodiment, after an ASL code method or set of ASL code methods complete, control or processor execution returns to the interrupt service routine that invoked the set of ASL code methods (block 309).

In one embodiment, the interrupt handler may notify other software components, resources or devices of the completed execution of the interrupt service routine (block 311). The interrupt handler may send a message, notification of changes or similar data to other software components, devices and resources in the computer system. In one embodiment, the notification may include notification that an ASL code method or set of ASL code methods associated with the interrupt service routine completed. The interrupt handler may continue to execute the interrupt service routine, additional interrupt service routines or other portions of the interrupt handler. When the interrupt handler completes, control and execution may return to the process or program that had control prior to the generation of the interrupt and the invocation of the interrupt handler (block 313). After the return of control to the appropriate program the operating system continues normal operation and awaits further interrupts to be serviced by the interrupt handler.

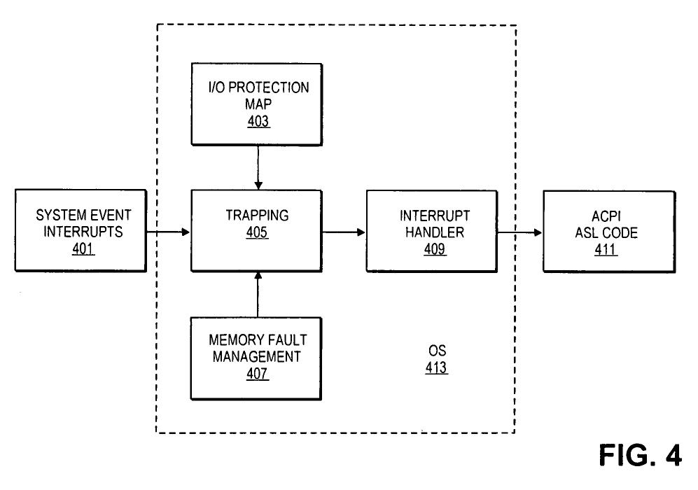

FIG. 4 is a diagram of one embodiment of a system for handling interrupts. In one embodiment, a system for handling interrupts may include trapping module 405 or similar software to detect events and activities in the computer system that generate interrupts. Trapping module 405 may be software that is part of an operating system 413 of the computer system. Trapping module 405 may receive input from hardware resources and devices. In one embodiment, trapping module 405 may receive system event interrupts 401 or similar hardware interrupts such as SCI interrupts from devices and resources in the computer system. For example, a hardware interrupt may be generated by a peripheral device such as a keyboard through an embedded controller and I/O controller. Trapping module 405 may also interact with other programs and data structures of operating system 413. In one embodiment, trapping module 405 may utilize an I/O protection map 403 to determine when accesses to I/O address space and ports generate a general protection fault or similar interrupt. Trapping module 405 may interact with memory fault management component 407 such as a page table and page boundary checking data structures and programs to determine when a page fault may be generated.

In one embodiment, when trapping module 405 determines that an interrupt has occurred, control may be passed to an interrupt handler 409. An interrupt handler may be a software program that analyzes an interrupt and executes an interrupt service routine that corresponds to that interrupt type. An interrupt handler 409 may be structured as a switch or similar logical structure for selecting a set of interrupt services routines. In one embodiment, an interrupt handler or interrupt service routine may invoke ACPI ASL code 411 or ACPI module containing ASL code during execution and handling of an interrupt. ACPI may be a set of data structures and control methods written in ASL code to handle the configuration and management of system resources such as power management.

In one embodiment, the interrupt handling system utilizes existing interrupt types such as general protection faults from I/O access and page faults from memory accesses. This system does not require changes to the architecture of the computer system and is backward compatible with programs, resources and devices that do not support the software generated interrupt scheme. The system overloads general protection faults, page faults and similar interrupt types. Overloading an interrupt type may provide additional functionality and utility to the interrupt type by utilizing the interrupt type to invoke specific code and service routines. Applications, devices and resources may utilize the scheme to gain access to ACPI data structures and control methods. Applications, drivers and similar resources may register with the operating system to obtain an address range of I/O address space or ports or virtual memory address space to utilize to generate software interrupts that will call designated interrupt service routines within the interrupt handler.

In one embodiment, the interrupt handling scheme provides greater flexibility to the architecture of the computer system and to the software and resources of the computer system. The computer system may eliminate the need for some or all hardware interrupt lines to service SCI and similar interrupt type events. This allows smaller and more efficient chipsets and components to be utilized in a system. Software, drivers and system resources have a greater degree of flexibility in handling and generating interrupts to service resources, devices and programs. An application, driver or similar resource may register any number of addresses and correlate them to different services, devices and routines. The interrupt system allows for the isolation of portions of ACPI ASL code and similar resources to precisely utilize the resources to accomplish a task by correlating a specific I/O or memory address range with a particular portion of the resource or code that services it.

In one embodiment, the software interrupt handling system may be utilized with software emulation and testing. The interrupt handling system allows for the generation of interrupts related to hardware resources and devices without requiring a hardware interrupt to be generated. For example, in a simulation environment a software based interrupt corresponding to a power button event may be generated by writing to a specified I/O or memory address instead of requiring a manual press of the power button. This system improves the efficiency of testing a system by allowing greater automation of the process. In one embodiment, a software emulator such as SoftSDV may be used to test ACPI ASL code without requiring that hardware base SCI interrupts be generated.

In one embodiment, the improved interrupt handling system may be implemented in software and stored or transmitted in a machine-readable medium. As used herein, a machine-readable medium is a medium that can store or transmit data such as a fixed disk, physical disk, optical disk, CDROM, DVD, floppy disk, magnetic disk, wireless device, infrared device, and similar storage and transmission technologies.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A method comprising:
determining a resource in a computer system to generate an interrupt; and
assigning an address to the resource, the address range to generate an interrupt when accessed for each resource in the set of resources by an operating system for the computer system.

2. The method of claim 1, wherein the address ranges are input output address ranges.

3. The method of claim 1, further comprising:
correlating an advanced configuration and power interface source language code method with an address range.

4. The method of claim 1, wherein the address ranges include system memory address ranges.

5. The method of claim 1, further comprising:
correlating a system control interrupt with an advanced configuration and power interface source language code method.

6. The method of claim 1, further comprising:
registering a device driver with an address range by the operating system.

7. A method comprising:
receiving an interrupt from an address access request;
determining the source of the interrupt based on the address access request; and
invoking an advanced configuration and power interface source language (ASL) code assigned to the address access request.

8. The method of claim 6, further comprising:
notifying a source of the address access request that the ASL code completed.

9. The method of claim 6, wherein the address access request is an input output address request.

10. The method of claim 6, wherein the address access request is a system memory address request.

11. A device comprising:
means for determining a resource in a computer system that requires an interrupt; and
means for correlating an address range with the resource to generate the interrupt when an access request for the address range is generated in the computer system.

12. The device of claim 11, wherein the address range comprises one of an input output address range and a system memory address range.

13. The device of claim 11, further comprising:
means for correlating an ASL code segment with the address range to handle the interrupt generated by the resource.

14. A device comprising:
an advanced configuration and power interface source language (ASL) code segment to handle a request of a resource;
an address protection module to manage the protection of an address space; and
an operating system level interrupt handler module to receive an interrupt when the address protection module detects an address space access and to invoke the ASL code segment corresponding to the address space access.

15. The device of claim 14, wherein the address protection module is an input output protection module that generates a general protection fault.

16. The device of claim 14, wherein the address protection module is a memory protection module that generates a page fault.

17. A system comprising:
a processor;
a memory device coupled to processor;
an advanced configuration and power interface (ACPI) module to manage power management resources; and
an operating system module executed by the processor to register a device driver to manage a system resource, the operating system module invoking the ACPI module when a memory access is received that corresponds to an address range registered by the device driver.

18. The system of claim 17, wherein the address range is an input output address range.

19. The system of claim 17, wherein the address range is a system memory address range.

20. A machine readable medium having instructions stored therein which when executed cause a machine to perform a set of operations comprising:
generating an interrupt based on an address access request corresponding to a predefined range;
determining the source of the interrupt based on the address access request; and
invoking an advanced configuration and power interface source language code assigned to the address access request.

21. The machine readable medium of claim 20, notifying a source of the address access request that the ASL code completed.

22. The method of claim 20, wherein the address access request is an input output address request.

23. The method of claim 20, wherein the address access request is a system memory address request.
